(19) United States
(12) Patent Application Publication
(10) Pub. No.: US 2025/0132916 A1
(43) Pub. Date: Apr. 24, 2025

(54) SYSTEMS AND METHODS OF AUTHORIZATION AND AUTHENTICATION BASED ON DEMONSTRATED PROOF OF POSSESSION AND DEVICE FINGERPRINT

(71) Applicant: Capital One Services, LLC, McLean, VA (US)

(72) Inventors: Jeffrey RULE, Chevy Chase, MD (US); Kevin OSBORN, Newton Highlands, MA (US); Jeffrey Carlyle WIEKER, Falls Church, VA (US)

(73) Assignee: Capital One Services, LLC, McLean, VA (US)

(21) Appl. No.: 18/918,157

(22) Filed: Oct. 17, 2024

Related U.S. Application Data
(60) Provisional application No. 63/544,668, filed on Oct. 18, 2023.

(51) Int. Cl. H04L 9/32

(52) U.S. Cl. CPC H04L 9/3213; H04L 9/3231

(57) ABSTRACT

An authorization and authentication method can comprise receiving, by a server from a user device, a request to generate an access token. The request includes a demonstration of proof of possession (DPoP) Java web token (JWT) that can include a public key, a payload, and a signature. The payload can include fingerprint data of the user device and a unique identifier of a contactless card associated with a user of the user device. The method can further comprise extracting, by the server, the DPoP JWT from the request to generate an access token and verifying, by the server, the signature using the public key included in the DPoP JWT. The method can further comprise authenticating, by the server, the payload, generating, by the server, the access token, binding, by the server, the public key to the access token, and transmitting, by the server, the access token to the user device.

### CROSS-REFERENCE TO RELATED APPLICATION

This application claims the priority of U.S. Provisional Patent Application No. 63/544,668, filed Oct. 18, 2023, the contents of which are incorporated herein by reference in their entirety.

### FIELD OF THE INVENTION

The present disclosure relates generally to data security, and more particularly, to systems and methods for authorization and authentication based on demonstration of proof of possession and device fingerprint.

### BACKGROUND

Data security and transaction integrity are of critical importance to businesses and consumers. Fraudulent actors will frequently try to exploit vulnerabilities in data storage, data transmission, and user authentication. In response, businesses frequently attempt to increase security by authenticating customers using multiple factors when transactions are being conducted.

Demonstration of proof of possession (DPoP) is a data security mechanism that ties an access token to a client and/or a device that receives the token. DPoP can prevent a stolen access token from being successfully used for an illegal application programming interface (API) calls. However, DPoP has limitations and, for example, can only perform an authorization of a transaction without an authentication of a user.

These and other deficiencies exist. Accordingly, there is a need to provide systems and methods that overcome these deficiencies to perform transaction authorization and authentication based on DPoP.

### SUMMARY

Aspects of the disclosed technology include systems and methods for authorization and authentication based on DPoP and device fingerprint.

Embodiments of the present disclosure provide a method for authorization and authentication. The method includes: receiving, by a server from a user device, a request to generate an access token, wherein the request includes a demonstration of proof of possession (DPoP) token, the DPoP token includes a public key, a payload and a signature, and the payload includes at least one selected from the group of fingerprint data of the user device and a unique identifier of a contactless card associated with a user of the user device; extracting, by the server, the DPoP token from the request to generate an access token; verifying, by the server, the signature using the public key included in the DPoP token; authenticating, by the server, the payload; generating, by the server, an access token; binding, by the server, the public key to the access token; and transmitting, by the server, the access token to the user device.

Embodiments of the present disclosure provide a system for authorization and authentication. The system includes a server. The server includes a processor and a memory coupled to the processor. The server is configured to: receive from a user device a request to generate an access token, wherein the request includes a demonstration of proof of possession (DPoP) token, the DPoP token includes a public key, a payload and a signature, and the payload includes at least one selected from the group of fingerprint data of the user device and a unique identifier of a contactless card associated with a user of the user device; extract the DPoP token from the request to generate an access token; verify the signature using the public key included in the DPoP token; authenticate the payload; generate an access token; bind the public key to the access token; and transmit the access token to the user device.

Embodiments of the present disclosure provide a non-transitory, computer-readable medium comprising instructions for authorization and authentication that, when executed on a computer arrangement, perform actions comprising: receiving from a user device a request to generate an access token, wherein the request includes a demonstration of proof of possession (DPoP) token; the DPoP token includes a public key, a payload and a signature; and the payload includes at least one selected from the group of fingerprint data of the user device and a unique identifier of a contactless card associated with a user of the user device; extracting the DPoP token from the request to generate an access token; verifying the signature using the public key included in the DPoP token; authenticating the payload; generating an access token; binding the public key to the access token; and transmitting the access token to the user device.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

FIG. 1 is a diagram of a system for authorization and authentication based on DPoP and device fingerprint according to an example embodiment.

FIG. 2A is a diagram of sequential interactions between components of the system in FIG. 1 according to an example embodiment.

FIG. 2B is a diagram of sequential interactions between components of the system in FIG. 1 according to an example embodiment.

FIG. 3 is a flow chart of a method for authorization and authentication based on DPoP and device fingerprint according to an example embodiment.

FIG. 4 is a flow chart of a method for authorization and authentication based on DPoP and device fingerprint according to an example embodiment.

FIG. 5 is a flow chart of a method for authorization and authentication based on DPoP and device fingerprint according to an example embodiment.

FIG. 6 is a flow chart of a method for authorization and authentication based on DPoP and device fingerprint according to an example embodiment.

FIG. 7 is a flow chart of a method for authorization and authentication based on DPoP and device fingerprint according to an example embodiment.

FIG. 8 is a diagram of a system for authorization and authentication based on DPoP and device fingerprint according to an example embodiment.

FIG. 9 is a diagram of a system for authorization and authentication based on DPoP and device fingerprint according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

The described features and teachings of the embodiments may be combined in any suitable manner. A person of ordinary skill in the art will recognize that the embodiments may be practiced without one or more of the specific features and teachings of an embodiment. In other instances, additional features and teachings may be recognized in certain embodiments that may not be present in all embodiments. A person of ordinary skill in the art will understand that the described features and teachings of any embodiment can be interchangeably combined with the features and teachings of any other embodiment.

The present disclosure is based on the DPoP standard that uses encryption to ensure that an access token and/or cookie is not moved between devices. The present disclosure can use a contactless card and/or device fingerprint to provide an authentication mechanism in the same payload used to authorize the DPoP.

In some embodiments, authentication is based on the DPoP by adding authentication data to the Java web token (JWT) of the DPoP so that authentication can occur in the same call made for authorization.

In some embodiments, a client side software development kit (SDK) in a website or application is able to read a contactless card tag generated by a payment card such as a credit card or other authentication device. A contactless card tag payload is included in the JWT token sent to an authorization server. The contactless card tag payload is then sent to an authentication server. The Authentication server decrypts the contactless card tag payload and authenticates the client associated with the contactless card. If there is a match with the contactless card, then the client is authenticated and authorized to use the resource server. For example, the client may be allowed to provision their personal identifiable information (PII) data and payment credentials securely on a merchant website or application and in a manner where an access token cannot be moved between devices.

In some embodiments, device fingerprint can be added as authentication data to the JWT of the DPoP so that authentication can occur in the same call made for Authorization. A client side SDK at a merchant or other client can read one or more fields of data (e.g., hundreds of fields) from the browser as the device fingerprint. This data is included in the JWT token sent to the authorization server. The device fingerprint is then sent to an authentication server. The authentication has a data store of previous encounters with clients and has stored device fingerprints. It can check to see if the client is likely to be who they claim to be. If there is a statistical match then the client is authenticated and authorized to use the resource server.

The present disclosure can combine contactless card and/or device fingerprint with DPoP for authentication and establishing secure non-transferable access tokens, and provide a method of authenticating and authorizing a client in a single payload for provisioning of resources, such as customer data and payment credentials.

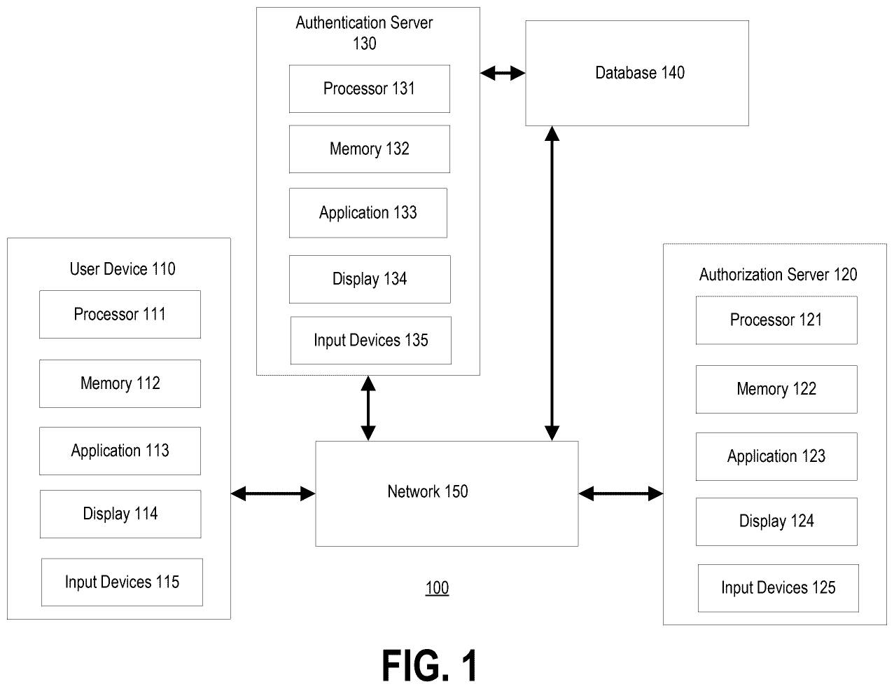

FIG. 1 illustrates a system 100 for authorizing and authenticating a user based on DPoP and device fingerprint according to an example embodiment. As further discussed below, the system 100 may include a user device 110, an authorization server 120, an authentication server 130, a database 140 in communication using a network 150, and/or a contactless card in signal communication with the user device 110. Although FIG. 1 illustrates single instances of the components, the system 100 may include any number of components.

The user device 110 may be associated with a customer/user of a merchant, a financial institution, or a resource provider with which interactions are conducted by the user through the user device 110.

The user device 110 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's shopping and financial account information.

The application 113 may comprise one or more software applications comprising instructions for execution on the user device 110. In some examples, the user device 110 may execute one or more applications, such as software applications, that enable, for example, network communications with one or more components of the system 100, transmit and/or receive data, and perform the functions described herein. Upon execution by the processor 111, the application 113 may provide the functions described in this specification, specifically to execute and perform the steps and functions in the process flows described herein. For example, the application 113 may be executed to perform generating device fingerprint and sending an authorization and authentication request to the authorization server 120. Such processes may be implemented in software, such as software modules, for execution by computers or other machines. The application 113 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

The authorization server 120 can be used by a merchant, a financial institution, or a service provider. For example, the authorization server 120 may be configured to present to the user a user interface from which the user may log into, for example, their bank or credit card account to access their transaction statement and/or financial information stored in the database 140. The user interface may also be configured to perform data communication with the contactless card. The authorization server 120 may be configured to display on the user interface a merchant's website, in response to a selection by the user of accessing the merchant's website.

The authorization server 120 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The authorization server 120 may include a processor 121, a memory 122, an application 123, a display 124, and input devices 125. The processor 121 may be a processor, a microprocessor, or other processor, and the authorization server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the authorization server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as private and personal information.

The application 123 may comprise one or more software applications comprising instructions for execution on the authorization server 120. In some examples, the authorization server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described herein. Such processes may be implemented in software, such as software modules, for execution by computers or other machines. The application 123 may provide graphic user interfaces (GUIs) through which users may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The authorization server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the authorization server 120 that is available and supported by the authorization server 120, such as a touch-screen, keyboard, mouse, cursor-control device, touch-screen, microphone, digital camera, video recorder or camcorder. These devices may be used to enter information and interact with the software and other devices described herein such as selecting an option of creating an online account with the merchant.

The authentication server 130 may be associated with an institution, such as a financial institution, and can be configured to communicate with the user device 110 and/or the authorization server 120. The institution associated with the authentication server 130 may issue the contactless card to the user and accordingly may authenticate the user based on the contactless card.

The authentication server 130 may be a network-enabled computer device. Exemplary network-enabled computer devices include, without limitation, a contactless card, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The authentication server 130 may include a processor 131, a memory 132, and an application 133. The processor 131 may be a processor, a microprocessor, or other processor, and the authentication server 130 may include one or more of these processors. The processor 131 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 131 may be coupled to the memory 132. The memory 132 may be a read-only memory, write-once read-multiple memory or read/write memory, e.g., RAM, ROM, and EEPROM, and the authentication server 130 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 132 may be configured to store one or more software applications, such as the application 133, and other data, such as user's financial account information and the contactless card information.

The application 133 may comprise one or more software applications, such as a card authentication module, comprising instructions for execution on the authentication server 130. In some examples, the authentication server 130 may execute one or more applications, such as software applications, that enable, for example, network communications with one or more components of the system 100, transmit and/or receive data, and perform the functions described herein. Upon execution by the processor 131, the application 133 may provide the functions described in this specification, specifically to execute and perform the steps and functions in the process flows described herein. For example, the card authentication module of the application 133 may be executed to perform authenticating the user based on the contactless card. Such processes may be implemented in software, such as software modules, for execution by computers or other machines. The application 133 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The authentication server 130 may further include a display 134 and input devices 135. The display 134 may be any type of device for presenting visual information such as a computer monitor, a flat panel display, and a mobile device screen, including liquid crystal displays, light-emitting diode displays, plasma panels, and cathode ray tube displays. The input devices 135 may include any device for entering information into the authentication server 130 that is available and supported by the authentication server 130, such as a touch-screen, keyboard, mouse, cursor-control device, touch-screen, microphone, digital camera, video recorder or camcorder. These devices may be used to enter information and interact with the software and other devices described herein.

The database 140 may be one or more databases configured to store date, including without limitation, device fingerprints, private information of users, financial accounts of users, contactless card information, online merchant account information, transactions of users, and merchant records indicative of corresponding merchants. The database 140 may comprise a relational database, a non-relational database, or other database implementations, and any combination thereof, including a plurality of relational databases and non-relational databases. In some examples, the database 140 may comprise a desktop database, a mobile database, or an in-memory database. Further, the database 140 may be hosted internally by the authorization server 120 and/or authentication server 130 or may be hosted externally of the authorization server 120 and/or authentication server 130, such as by a server, by a cloud-based platform, or in any storage device that is in data communication with the authorization server 120 and/or authentication server 130.

The system 100 may include one or more networks 150. In some examples, the network 150 may be one or more of a wireless network, a wired network or any combination of wireless network and wired network, and may be configured to connect the user device 110, the authorization server 120, the authentication server 130, and the database 140. For example, the network 150 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 150 may include, without limitation, telephone lines, fiber optics, IEEE Ethernet 902.3, a wide area network, a wireless personal area network, a LAN, or a global network such as the Internet. In addition, the network 150 may support an Internet network, a wireless communication network, a cellular network, or the like, or any combination thereof. The network 150 may further include one network, or any number of the exemplary types of networks mentioned above, operating as a stand-alone network or in cooperation with each other. The network 150 may utilize one or more protocols of one or more network elements to which they are communicatively coupled. The network 150 may translate to or from other protocols to one or more protocols of network devices. Although the network 150 is depicted as a single network, it should be appreciated that according to one or more examples, the network 150 may comprise a plurality of interconnected networks, such as, for example, the Internet, a service provider's network, a cable television network, corporate networks, such as credit card association networks, and home networks. The network 150 may further comprise, or be configured to create, one or more front channels, which may be publicly accessible and through which communications may be observable, and one or more secured back channels, which may not be publicly accessible and through which communications may not be observable.

In some examples, communications between the user device 110, authentication server 130, and authorization server 120 using the network 150 can occur using one or more front channels and one or more secure back channels. A front channel may be a communication protocol that employs a publicly accessible and/or unsecured communication channel such that a communication sent to the user device 110, authentication server 130, and/or authorization server 120 may originate from any other device, whether known or unknown to the user device 110, authentication server 130, and/or authorization server 120, if that device possesses the address (e.g., network address, Internet Protocol (IP) address) of the user device 110, authentication server 130, and/or authorization server 120. Exemplary front channels include, without limitation, the Internet, an open network, and other publicly-accessible communication networks. In some examples, communications sent using a front channel may be subject to unauthorized observation by another device. In some examples, front channel communications may comprise Hypertext Transfer Protocol (HTTP) secure socket layer (SSL) communications, HTTP Secure (HTTPS) communications, and browser-based communications with a server or other device.

A secure back channel may be a communication protocol that employs a secured and/or publicly inaccessible communication channel. A secure back channel communication sent to the user device 110, authentication server 130, and/or authorization server 120 may not originate from any device, and instead may only originate from a selective number of parties. In some examples, the selective number of devices may comprise known, trusted, or otherwise previously authorized devices. Exemplary secure back channels include, without limitation, a closed network, a private network, a virtual private network, an offline private network, and other private communication networks. In some examples, communications sent using a secure back channel may not be subject to unauthorized observation by another device. In some examples, secure back channel communications may comprise Hypertext Transfer Protocol (HTTP) secure socket layer (SSL) communications, HTTP Secure (HTTPS) communications, and browser-based communications with a server or other device.

The contactless card may be any type of card, such as a security card, a payment card, an identification card, and the like. The contactless card may be issued to the user by the financial institution for identity verification for the bank account of the user.

The contactless card can be configured to transmit a cryptogram to the authorization server 120 upon tapping to the user device 110. The user device 110 may be configured to read the cryptogram from the contactless card after entry of the contactless card into a communication field of the user device 110. The user device 110 may then transmit the cryptogram to the authorization server 120 and then to the authentication server 130. The authentication server 130 may be configured to verify the cryptogram by searching the database 140.

The contactless card can perform authentication and numerous other functions that may otherwise require a user to carry a separate physical token in addition to the contactless card. By employing a contactless interface, the contactless card 160 may be provided with a method to interact and communicate between a user's device (such as a mobile phone) and the card itself. For example, the Europay, Mastercard, and Visa (EMV) protocol, which underlies many credit card transactions, includes an authentication process which suffices for operating systems for Android® but presents challenges for iOS®, which is more restrictive regarding near field communication (NFC) usage, as it can be used only in a read-only manner.

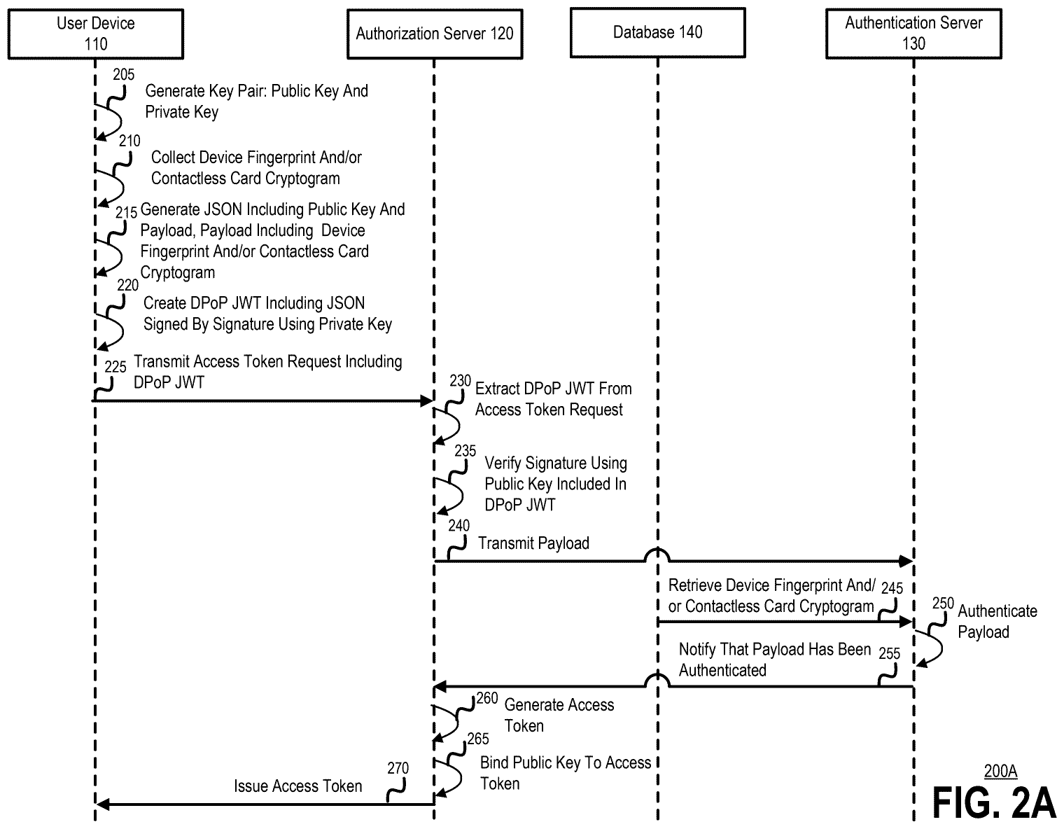

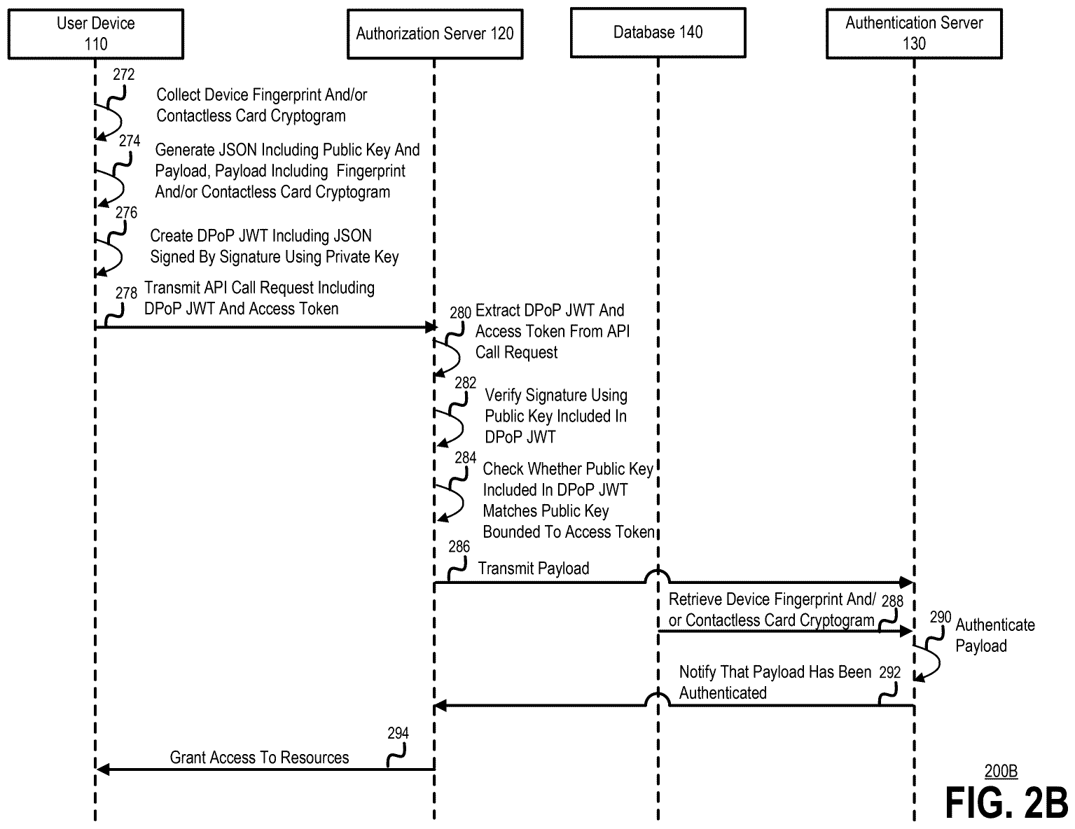

FIG. 2A illustrates an example diagram 200A of sequence interaction between the components of the system 100 for an access token request according to an example embodiment. FIG. 2A may reference the same or similar components as those illustrated in FIG. 1, including an authorization server, an authentication server, a database, a user device and a contactless card.

In step 205, an application (e.g., the application 113) on the user device 110 generates a key pair. The key pair includes a public key and a private key.

In step 210, the user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device.

In some embodiments, the device fingerprint of the user device 110 can be collected by a client side SDK deployed on the user device 110 by a merchant or a financial institution. The SDK may be able to read one or more fields of data (e.g., hundreds of fields) from the web browser of the user device 110.

In some embodiment, the user device 110 may also collect through the application of the user device a contactless card cryptogram. The contactless card cryptogram includes a unique identifier that can associated the user with the contactless card. The contactless card cryptogram can be received by the application of the user device 110 when the user taps the contactless card to the user device 110. The unique identifier can be used to verify and validate the user.

In step 215, the user device 110 generates a JavaScript Object Notation (JSON) token including the public key and a payload. The payload includes the device fingerprint and/or contactless card cryptogram collected above by the user device 110. The JSON token will be used as the header of the JWT and the payload corresponds to an access token request.

In step 220, the user device 110 creates DPoP JWT including the JSON token signed by a signature using the private key. In this step, the user device 110 creates the signature using the private key to sign the JSON token. The user device 110 packs the JSON token and the signature to create JWT which is referred to as a DPoP JWT.

In step 225, the user device 110 transmits an access token request to the authorization server 120. In this step, the user device 110 creates the access token request by including the DPoP JWT into the token request.

In step 230, the authorization server 120 extracts the DPoP JWT from the access token request. In step 235, the authorization server 120 verifies the signature using the public key included in the DPoP JWT. The verification ensures that the application of the user device 110 has the private key which corresponds to the public key.

In step 240, the authorization server 120 transmits the payload to the authentication server 130. In step 245, the authentication server 130 retrieves device fingerprint and/or contactless card cryptogram previously stored in the database 140.

In step 250, the authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110.

The authentication server 130 may transmit to the authorization server 120 a notification indicating whether the payload is authenticated. For example, if the authentication server 130 authenticates the payload, in step 255, the authentication server 130 may transmit to the authorization server 120 a notification notifying that the payload has been authenticated.

In step 260, the authorization server 120 can generate an access token based on the successful signature verification and the payload authentication. In step 265, the authorization server 120 binds the public key to the access token. For example, binding the public key to the access token can be achieved by remembering the hash value of the public key as one attribute of the access token. As an example, the hash value can be “JWK SHA-256 Thumbprint”.

In step 270, the authorization server 120 transmits the access token to the user device 110. The user device 110 can then use the access token to access resources that are authorized by the authorization server 120.

FIG. 2B illustrates an example diagram 200B of sequence interaction between the components of the system 100 for an API call request using the access token according to an example embodiment. FIG. 2B may reference the same or similar components as those illustrated in FIG. 1, including an authorization server, an authentication server, a database, a user device and a contactless card.

In step 272, the user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device.

In some embodiments, the device fingerprint of the user device 110 can be collected by a SDK deployed on the user device 110 by a merchant or a financial institution. The SDK may be able to read one or more fields of data (e.g., hundreds of fields) from the web browser of the user device 110.

In some embodiment, the user device 110 may also collect through the application of the user device 110 a contactless card cryptogram. The contactless card cryptogram includes a unique identifier that can associated the user with the contactless card. The contactless card cryptogram can be received by the application of the user device 110 when the user taps the contactless card to the user device 110. The unique identifier can be used to verify and validate the user.

In step 274, the user device 110 generates a JSON token including the public key and a payload. The payload includes the device fingerprint and/or contactless card cryptogram collected above by the user device 110. The JSON token will be used as the header of the JWT and the payload corresponds to an API call request.

In step 276, the user device 110 creates a DPoP JWT including the JSON token signed by a signature using the private key. In this step, the user device 110 creates the signature using the private key to sign the JSON token. The user device 110 packs the JSON token and the signature to create the DPoP JWT.

In step 278, the user device 110 transmits an API call request to the authorization server 120 for access resources. In this step, the user device 110 creates the API call request by including the DPoP JWT and the access token into the API call request.

In step 280, the authorization server 120 extracts the DPoP JWT and the access token from the API call request. In step 282, the authorization server 120 verifies the signature using the public key included in the DPoP JWT. The verification ensures that the application of the user device 110 has the private key which corresponds to the public key.

In step 284, the authorization server 120 checks whether public key included in the DPoP JWT matches the public key bounded to the access token. For example, the authorization server 120 may compares the hash value of the public key included in the DPoP JWT with the hash value of the public key bounded to the access token. If they match, the access token included in the API call request can be verified to be the access token issued to the user device 110 and the API call request is from the user device 110.

In step 286, the authorization server 120 transmits the payload to the authentication server 130. In step 288, the authentication server 130 retrieves device fingerprint and/or contactless card cryptogram previously stored in the database 140.

In step 290, the authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110.

The authentication server 130 may transmit to the authorization server 120 a notification indicating whether the payload is authenticated. For example, if the authentication server 130 authenticates the payload, in step 292, the authentication server 130 may transmit to the authorization server 120 a notification notifying that the payload has been authenticated.

In step 294, the authorization server 120 can grant the user device 110 to access the requested resources based on the successful signature verification and the payload authentication.

As can been seen, both the authorization and authentication can be performed each time for the access token creation as well as each subsequent use of the access token. The device fingerprint as well as the contactless card cryptogram can be used as a two-factor authentication. In this way, a user can be confirmed to have both the user device 110 and the contactless card.

In some embodiment, the device fingerprint and the contactless card cryptogram can be supplied separately and on a separate confirmation. For example, the payload may include the device fingerprint only and the contactless card cryptogram can be transmitted separately to the authorization server 120 and/or the authentication server 130. In some examples, the device fingerprint may be included in a first payload and the contactless card cryptogram can be included in a second payload which is a different payload from the first payload.

In some embodiments, the authentication can be performed by a third party. For example, the authentication server 130 can be associated with a third party who is not a merchant or a financial institution. The third party may have device fingerprint and user personal identifiable information of users associated with the merchant or the financial institution. For example, the third party can be an early warning system as a central authority that aggregates device fingerprint and user personal identifiable information of users associated with the merchant or the financial institution. Then early warning system can then do the authentication on behalf of the merchant or the financial institution.

The contactless card cryptogram can be generated by the contactless card and collected by the user device 110. For example, the user device 110 can transmit an NFC prompt and/or query to the contactless card. The user device 110 may include an NFC interface configured for establishing an NFC communication with other NFC-equipped devices (the contactless card in this embodiment). The NFC interface of the user device 110 is configured for establishing NFC communication when a passive NFC tag or other NFC-enabled device is brought into the magnetic field and within the NFC communication range of the user device 110. The NFC interface of the user device 110 is configured, in particular, for communication with the NFC-enabled contactless card when the contactless card is brought within communication range of the user device 110 (such as, the contactless card is tapped by the user to the user device 110). As used herein, a tap of the contactless card to the user device 110 may not indicate that the contactless card is in a physical contact with the user device 110. A tap of the contactless card to the user device 110 may refer to entry of the contactless card into the NFC communication field of the user device 110. In response, after entry of the contactless card into the NFC communication field of the user device 110, the contactless card can generate a cryptogram and transmit it to the user device 110. The cryptogram may be or include, for example, security information encrypted by the contactless card using a private key unique to the contactless card that is known only to the contactless card account administrator (e.g., the authentication server 130). The cryptogram includes the unique identifier of the contactless card that can identify the user. The authentication server 130 can validate the cryptogram, decrypt the cryptogram and extract the unique identifier of the contactless card. The authentication server 130 may authenticate the user based on the unique identifier of the contactless card.

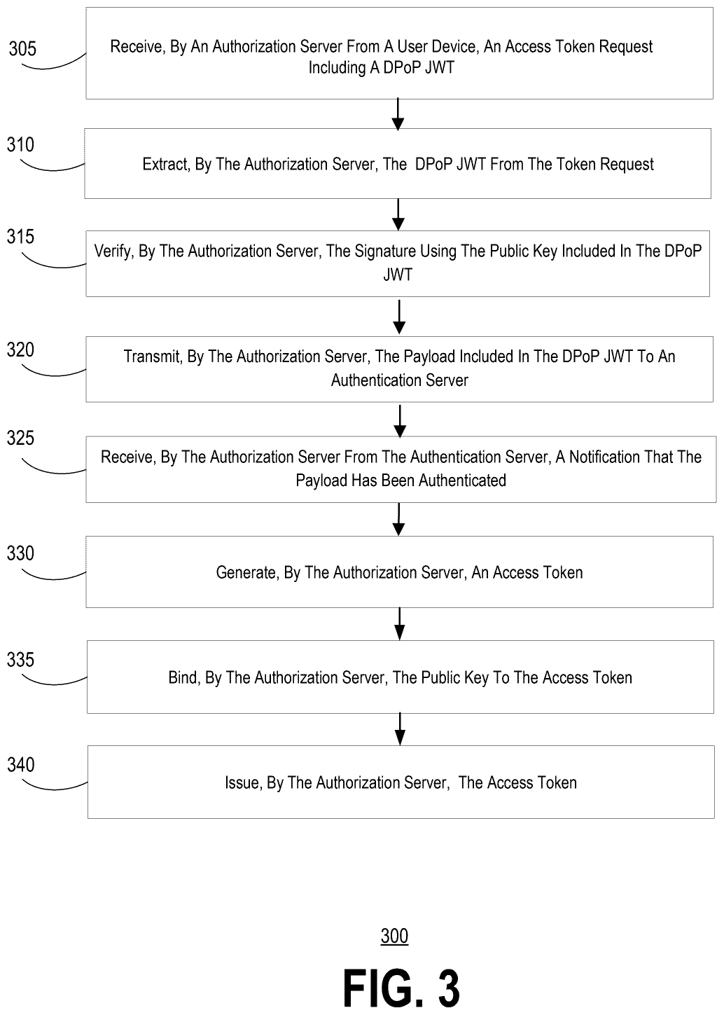

FIG. 3 illustrates a flow chart of an example method 300 for authorizing and authenticating a user based on DPoP and device fingerprint/contactless card cryptogram according to an example embodiment. FIG. 3 may reference the same or similar components as those illustrated in FIGS. 1-2, including an authorization server, an authentication server, a database, a user device, and a contactless card. The method 300 can be implemented in the system 100 and may include, but is not limited to the following steps.

In step 305, the authorization server 120 receives from the user device 110, an access token request including a DPoP Proof JWT. The application 113 on the user device 110 generates a key pair. The key pair includes a public key and a private key. The user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device. In some embodiments, the device fingerprint of the user device 110 can be collected by a client side SDK deployed on the user device 110 by a merchant or a financial institution. The SDK may be able to read one or more fields of data (e.g., hundreds of fields) from the web browser of the user device 110. In some embodiment, the user device 110 may also collect through the application of the user device a contactless card cryptogram. The contactless card cryptogram includes a unique identifier that can be associated the user with the contactless card. The contactless card cryptogram can be received by the application of the user device 110 when the user taps the contactless card to the user device 110. The unique identifier can be used to verify and validate the user. The user device 110 generates a JSON token including the public key and a payload. The payload includes the device fingerprint and/or contactless card cryptogram collected above by the user device 110. The JSON token will be used as the header of the JWT and the payload corresponds to a token request. The user device 110 creates a DPoP JWT including the JSON token signed by a signature using the private key. The user device 110 creates the signature using the private key to sign the JSON token. The user device 110 packs the JSON token and the signature to create the DPoP JWT. The user device 110 transmits an access token request to the authorization server 120. The user device 110 creates the access token request by including the DPoP JWT into the access token request. Accordingly, the authorization server 120 receives from the user device 110, the access token request including the DPoP Proof JWT.

In step 310, the authorization server 120 extracts the DPoP JWT from the token request. In step 315, the authorization server 120 verifies the signature using the public key included in the DPoP JWT. The verification ensures that the application of the user device 110 has the private key which corresponds to the public key.

In step 320, the authorization server 120 transmits the payload included in the DPoP JWT to the authentication server 130. The authentication server 130 retrieves device fingerprint and/or contactless card cryptogram previously stored in the database 140. The authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110. The authentication server 130 may transmit to the authorization server 120 a notification indicating whether the payload is authenticated. For example, if the authentication server 130 authenticates the payload, the authentication server 130 may transmit to the authorization server 120 a notification notifying that the payload has been authenticated. Accordingly, in step 325, the authorization server 120 receives from the authentication server 130, the notification that the payload has been authenticated.

In step 330, the authorization server 120 can generate an access token based on the successful signature verification and the payload authentication. In step 335, the authorization server 120 binds the public key to the access token. For example, binding the public key to the access token can be achieved by remembering the hash value of the public key as one attribute of the access token. As an example, the hash value can be “JWK SHA-256 Thumbprint”.

In step 340, the authorization server 120 transmits the access token to the user device 110. The user device 110 can then use the access token to access resources that are authorized by the authorization server 120.

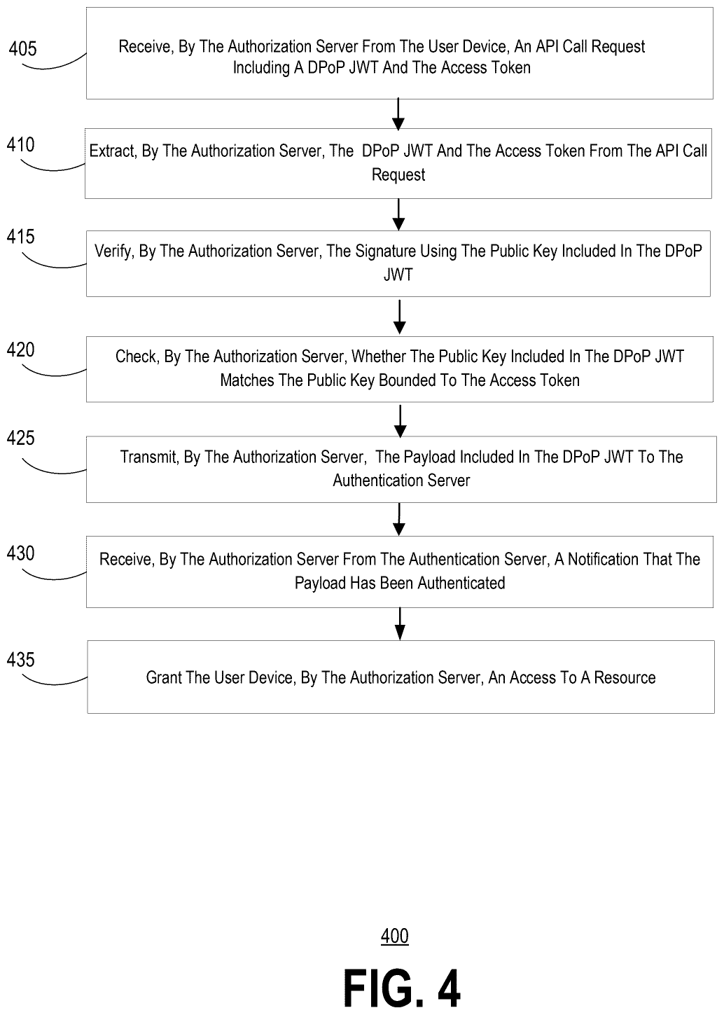

FIG. 4 illustrates a flow chart of an example method 400 for authorizing and authenticating a user based on DPoP and device fingerprint/contactless card cryptogram for an API call request using the access token according to an example embodiment. FIG. 4 may reference the same or similar components as those illustrated in FIGS. 1-3, including an authorization server, an authentication server, a database, a user device, and a contactless card. The method 400 can be implemented in the system 100 and may include, but is not limited to the following steps.

In step 405, the authorization server 120 receives from the user device 110, an API call request including a DPoP Proof JWT and the access token for accessing resources. The user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device. In some embodiments, the device fingerprint of the user device 110 can be collected by a SDK deployed on the user device 110 by a merchant or a financial institution. The SDK may be able to read one or more fields of data (e.g., hundreds of fields) from the web browser of the user device 110. In some embodiment, the user device 110 may also collect through the application of the user device 110 a contactless card cryptogram. The contactless card cryptogram includes a unique identifier that can associated the user with the contactless card. The contactless card cryptogram can be received by the application of the user device 110 when the user taps the contactless card to the user device 110. The unique identifier can be used to verify and validate the user. The user device 110 generates a JSON token including the public key and a payload. The payload includes the device fingerprint and/or contactless card cryptogram collected above by the user device 110. The JSON token will be used as the header of the JWT and the payload corresponds to the API call request. The user device 110 creates a DPoP JWT including the JSON token signed by a signature using the private key. The user device 110 creates the signature using the private key to sign the JSON token. The user device 110 packs the JSON token and the signature to create the DPoP JWT. The user device 110 transmits the API call request to the authorization server 120 for access resources. The user device 110 creates the API call request by including the DPoP JWT and the access token into the API call request. Accordingly, the authorization server 120 receives from the user device 110, the API call request including the DPoP Proof JWT and the access token for accessing resources.

In step 410, the authorization server 120 extracts the DPoP JWT and the access token from the API call request. In step 415, the authorization server 120 verifies the signature using the public key included in the DPoP JWT. The verification ensures that the application of the user device 110 has the private key which corresponds to the public key.

In step 420, the authorization server 120 checks whether public key included in the DPoP JWT matches the public key bounded to the access token. For example, the authorization server 120 may compares the hash value of the public key included in the DPoP JWT with the hash value of the public key bounded to the access token. If they match, the access token included in the API call request can be verified to be the access token issued to the user device 110 and the API call request is from the user device 110.

In step 425, the authorization server 120 transmits the payload to the authentication server 130. The authentication server 130 retrieves device fingerprint and/or contactless card cryptogram previously stored in the database 140. The authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110. The authentication server 130 may transmit to the authorization server 120 a notification indicating whether the payload is authenticated. For example, if the authentication server 130 authenticates the payload, the authentication server 130 may transmit to the authorization server 120 a notification notifying that the payload has been authenticated. Accordingly, in step 430, the authorization server 120 receives from the authentication server 130 the notification notifying that the payload has been authenticated.

In step 435, the authorization server 120 can grant the user device 110 to access the requested resources based on the successful signature verification and the payload authentication.

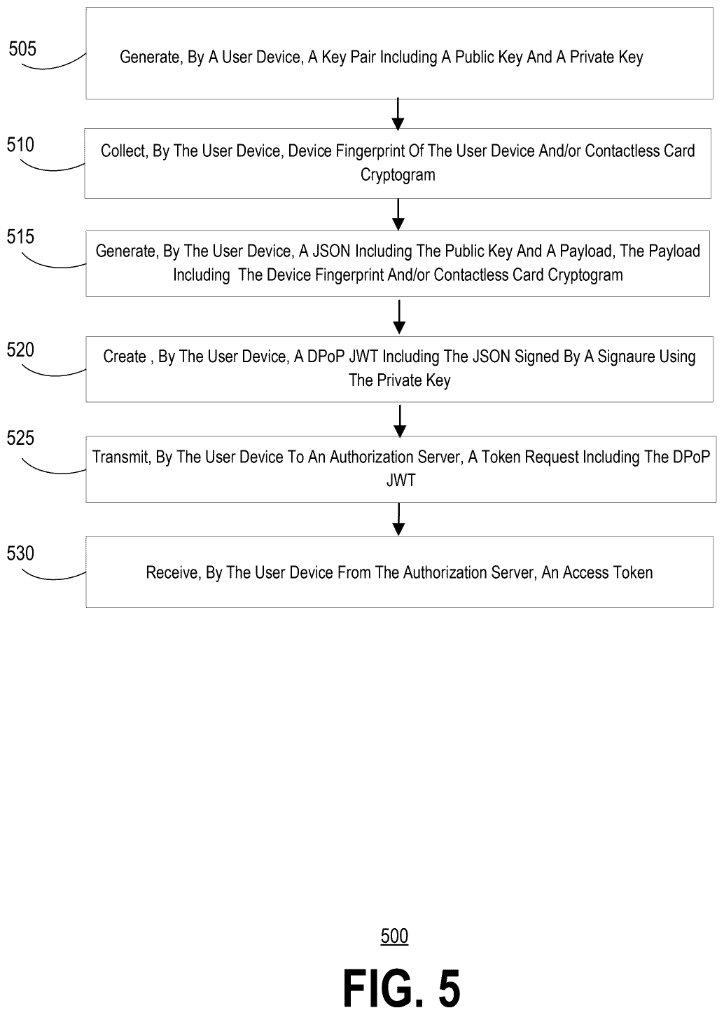

FIG. 5 illustrates a flow chart of an example method 500 for authorizing and authenticating a user based on DPoP and device fingerprint/contactless card cryptogram according to an example embodiment. FIG. 5 may reference the same or similar components as those illustrated in FIGS. 1-4, including an authorization server, an authentication server, a database, a user device, and a contactless card. The method 500 can be implemented in the system 100 and may include, but is not limited to the following steps.

In step 505, the application 113 on the user device 110 generates a key pair. The key pair includes a public key and a private key.

In step 510, the user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device.

In some embodiments, the device fingerprint of the user device 110 can be collected by a client side SDK deployed on the user device 110 by a merchant or a financial institution. The SDK may be able to read one or more fields of data (e.g., hundreds of fields) from the web browser of the user device 110.

In some embodiment, the user device 110 may also collect through the application of the user device a contactless card cryptogram. The contactless card cryptogram includes a unique identifier that can be associated the user with the contactless card. The contactless card cryptogram can be received by the application of the user device 110 when the user taps the contactless card to the user device 110. The unique identifier can be used to verify and validate the user.

In step 515, the user device 110 generates a JSON token including the public key and a payload. The payload includes the device fingerprint and/or contactless card cryptogram collected above by the user device 110. The JSON token will be used as the header of the JWT and the payload corresponds to a token request.

In step 520, the user device 110 creates a DPoP JWT including the JSON token signed by a signature using the private key. The user device 110 creates the signature using the private key to sign the JSON token. The user device 110 packs the JSON token and the signature to create the DPoP JWT.

In step 525, the user device 110 transmits an access token request to the authorization server 120. The user device 110 creates the access token request by including the DPoP JWT into the access token request.

In step 530, the user device 110 receives an access token from the authorization server 120. After the authorization server 120 receives the access token request from the user device 110, the authorization server 120 extracts the DPoP JWT from the token request. The authorization server 120 verifies the signature using the public key included in the DPoP JWT. The verification ensures that the application of the user device 110 has the private key which corresponds to the public key. The authorization server 120 transmits the payload included in the DPoP JWT to the authentication server 130. The authentication server 130 retrieves device fingerprint and/or contactless card cryptogram previously stored in the database 140. The authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110. The authentication server 130 may transmit to the authorization server 120 a notification indicating whether the payload is authenticated. For example, if the authentication server 130 authenticates the payload, the authentication server 130 may transmit to the authorization server 120 a notification notifying that the payload has been authenticated. After the authorization server 120 receives from the authentication server 130, the notification that the payload has been authenticated. The authorization server 120 can generate an access token based on the successful signature verification and the payload authentication. The authorization server 120 binds the public key to the access token. For example, binding the public key to the access token can be achieved by remembering the hash value of the public key as one attribute of the access token. As an example, the hash value can be “JWK SHA-256 Thumbprint”. Then authorization server 120 transmits the access token to the user device 110. The user device 110 can then use the access token to access resources that are authorized by the authorization server 120.

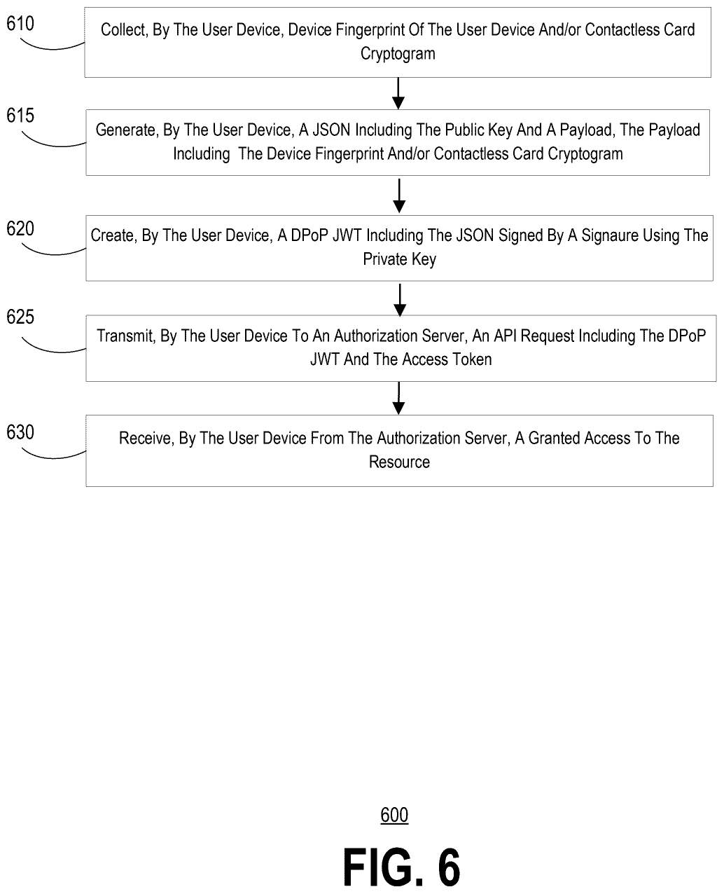

FIG. 6 illustrates a flow chart of an example method 600 for authorizing and authenticating a user based on DPoP and device fingerprint/contactless card cryptogram for an API call request using the access token according to an example embodiment. FIG. 6 may reference the same or similar components as those illustrated in FIGS. 1-5, including an authorization server, an authentication server, a database, a user device, and a contactless card. The method 600 can be implemented in the system 100 and may include, but is not limited to the following steps.

In step 610, the user device 110 collects device fingerprint of the user device 110 through the application on the user device 110. The device fingerprint may include, but is not limited to, browser settings of browsers on the user device 110, identification information that can identify the user device 110, the processor type of the user device 110, the operation system of the user device 110, the memory capacity of the user device 110, and/or the WIFI type of the user device.

In some embodiments, the device fingerprint of the user device 110 can be collected by a SDK deployed on the user device 110 by a merchant or a financial institution. The SDK may be able to read one or more fields of data (e.g., hundreds of fields) from the web browser of the user device 110.

In some embodiment, the user device 110 may also collect through the application of the user device 110 a contactless card cryptogram. The contactless card cryptogram includes a unique identifier that can associated the user with the contactless card. The contactless card cryptogram can be received by the application of the user device 110 when the user taps the contactless card to the user device 110. The unique identifier can be used to verify and validate the user.

In step 615, the user device 110 generates a JSON token including the public key and a payload. The payload includes the device fingerprint and/or contactless card cryptogram collected above by the user device 110. The JSON token will be used as the header of the JWT and the payload corresponds to the API call request.

In step 620, the user device 110 creates a DPoP JWT including the JSON token signed by a signature using the private key. The user device 110 creates the signature using the private key to sign the JSON token. The user device 110 packs the JSON token and the signature to create the DPoP JWT.

In step 625, the user device 110 transmits an API call request to the authorization server 120 for access resources. The user device 110 creates the API call request by including the DPoP JWT and the access token into the API call request. Accordingly, the authorization server 120 receives from the user device 110, the API call request including the DPoP Proof JWT and the access token for accessing resources. The authorization server 120 extracts the DPoP JWT and the access token from the API call request. The authorization server 120 verifies the signature using the public key included in the DPoP JWT. The verification ensures that the application of the user device 110 has the private key which corresponds to the public key. The authorization server 120 checks whether public key included in the DPoP JWT matches the public key bounded to the access token. For example, the authorization server 120 may compares the hash value of the public key included in the DPoP JWT with the hash value of the public key bounded to the access token. If they match, the access token included in the API call request can be verified to be the access token issued to the user device 110 and the API call request is from the user device 110. The authorization server 120 transmits the payload to the authentication server 130. The authentication server 130 retrieves device fingerprint and/or contactless card cryptogram previously stored in the database 140. The authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110. The authentication server 130 may transmit to the authorization server 120 a notification indicating whether the payload is authenticated. For example, if the authentication server 130 authenticates the payload, the authentication server 130 may transmit to the authorization server 120 a notification notifying that the payload has been authenticated.

After the authorization server 120 receives from the authentication server 130 the notification notifying that the payload has been authenticated, the authorization server 120 can grant the user device 110 to access the requested resources based on the successful signature verification and the payload authentication. Accordingly, in step 630, the user device 110 receives from the authorization server 120, a granted access to the resource.

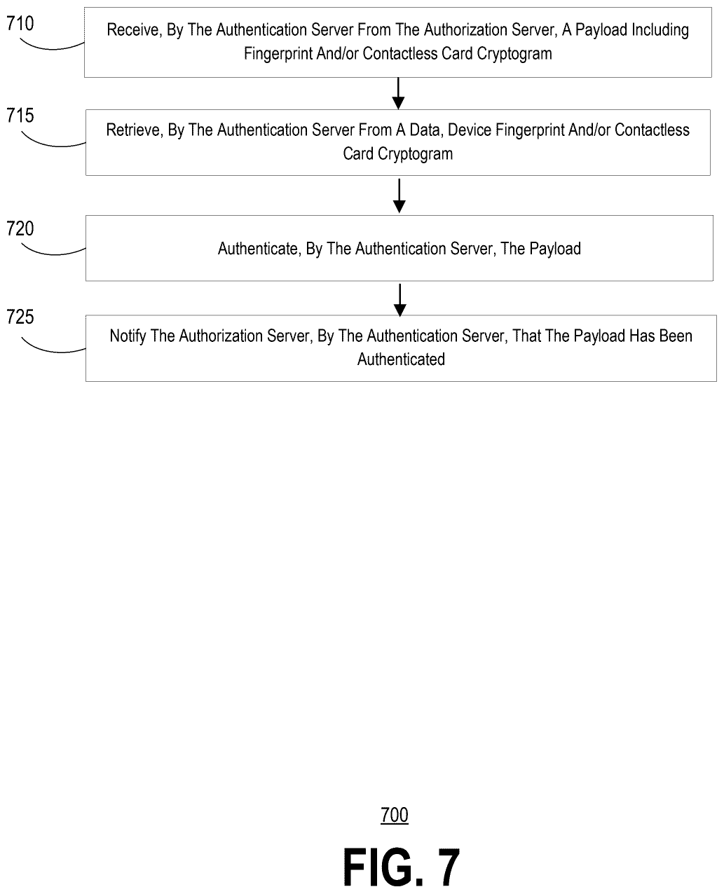

FIG. 7 illustrates a flow chart of an example method 700 for authenticating a payload based on DPoP and device fingerprint/contactless card cryptogram according to an example embodiment. FIG. 7 may reference the same or similar components as those illustrated in FIGS. 1-6, including an authorization server, an authentication server, a database, a user device, and a contactless card. The method 700 can be implemented in the system 100 and may include, but is not limited to the following steps.

In step 710, the authentication server 130 receives a payload from the authorization server 120. As described above, the payload can include device fingerprint of the user device 110 and a contactless card cryptogram of a contactless card.

In step 715, the authentication server 130 retrieves device fingerprint and/or contactless card cryptogram previously stored in the database 140.

In step 720, the authentication server 130 authenticates the payload. For example, the authentication server 130 compares the received device fingerprint in the payload with the retrieved device fingerprint from the database 140 to determine whether the received device fingerprint matches with the retrieved device fingerprint (e.g., statistically match). If they match, the authentication server 130 authenticates the payload and determines the payload is from the user device 110; if not, the authentication server 130 can determine the payload is not from the user device 110. In some embodiment, if the contactless card cryptogram is included in the payload, the authentication server 130 compares the received contactless card cryptogram in the payload with the retrieved contactless card cryptogram from the database 140 to determine whether the received contactless card cryptogram matches with the retrieved contactless card cryptogram. If they match, the authentication server 130 authenticates the payload and determines the payload is from the user device 110; if not, the authentication server 130 can determine the payload is not from the user device 110.

In step 725, the authentication server 130 may transmit to the authorization server 120 a notification indicating whether the payload is authenticated. For example, if the authentication server 130 authenticates the payload, the authentication server 130 may transmit to the authorization server 120 a notification notifying that the payload has been authenticated.

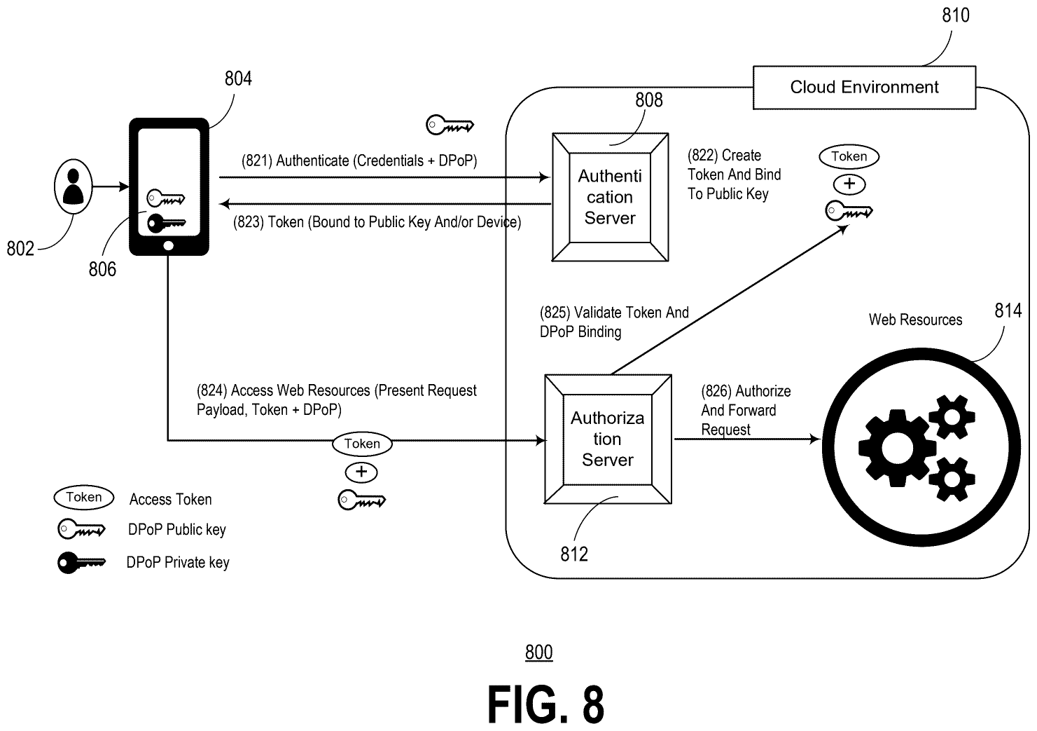

FIG. 8 illustrates a flow diagram of an authorization and authentication system 800 based on DPoP according to an example embodiment. A user 802 may generate an access token request using a user device 804. An application on the user device 804 generates a key pair 806. The key pair 806 includes a public key and a private key.

In step 821, the user device 804 transmits the access token request to an authentication server 808. The authentication server 808 may be hosted in a cloud computing environment 810. The access token request includes credentials and a DPoP JWT for authentication. The credentials may include personal identifiable information (e.g., social security number) and/or account login information of the user 802. The DPoP JWT may include the public key and a signature generated using the private key.

In step 822, the authentication server 808 extracts the DPoP JWT from the access token request. The authentication server 808 verifies the signature using the public key included in the DPoP JWT. The verification ensures that the application of the user device 110 has the private key which corresponds to the public key. The authentication server 808 can create an access token based on the successful signature verification. The authentication server 808 binds the public key to the access token. For example, binding the public key to the access token can be achieved by remembering the hash value of the public key as one attribute of the access token. As an example, the hash value can be “JWK SHA-256 Thumbprint”.

In step 823, The authentication server 808 transmits the access token to the user device 804. Since the public key is generated by the user device 804, binding the public key to the access token indicates that the access token is bound to the user device 804.

The user device 804 can then use the access token to access web resources 814 that are authorized by an authorization server (e.g., web gateway) 812.

In step 824, the user device 804 transmits an access web resources request to the authorization server 812 for accessing the web resources 814. The access web resources request may include a DPoP JWT and the access token. The DPoP JWT may include the public key and a signature generated using the private key. The DPoP JWT may also include a payload corresponding to the access web resources request.

In step 825, the authorization server 812 extracts the DPoP JWT and the access token from the access web resources request. The authorization server 812 verifies the signature using the public key included in the DPoP JWT. The verification ensures that the application of the user device 804 has the private key which corresponds to the public key. The authorization server 812 checks whether the public key included in the DPoP JWT matches the public key bounded to the access token. For example, the authorization server 812 may compares the hash value of the public key included in the DPoP JWT with the hash value of the public key bounded to the access token. If they match, the access token included in the access web resources request can be verified to be the access token issued to the user device 804 and the access web resources request is from the user device 804. That is, the authorization server 812 validates the access token and DPoP JWT binding.

In step 826, the authorization server 812 authorizes the user device 804 to access the requested web resources 814 and forward the access web resources request to the web resources 814. Therefore, the user device 804 is granted access to the web resources 814.

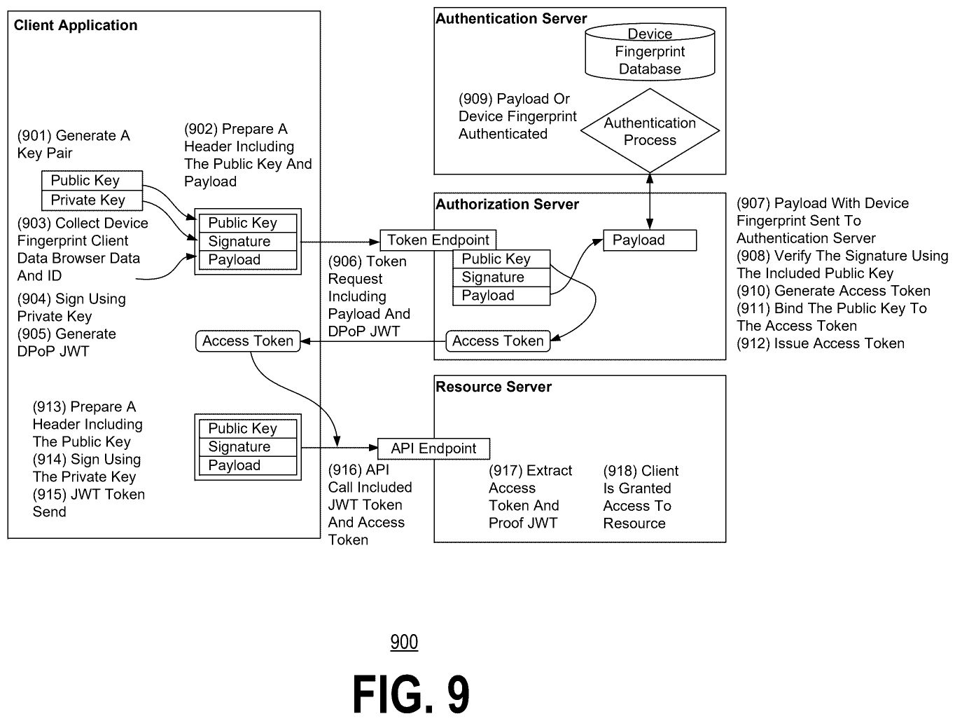

FIG. 9 illustrates a flow diagram of an authorization and authentication system 900 based on DPoP and device fingerprint and/or contactless card cryptogram according to an example embodiment. For a client application such as a web page application running on a user device, in step 901, the client application generates a key pair. The key pair includes a public key and a private key.

In step 902, the client application prepares a header including the public key and a payload. In step 903, the client application collects device fingerprint of the user device. The device fingerprint may include, but is not limited to, client data, browser data, IP address, existing cookies, and/or data fields along with IDs such as an email address. The client application can be a client side SDK deployed on the user device by a merchant or a financial institution. In some embodiment, the device fingerprint may include a contactless card cryptogram of a contactless card tapped to the user device. The contactless card cryptogram includes a unique identifier that can associated a user with the contactless card. The unique identifier can be used to verify and validate the user. The client application packs the device fingerprint into the payload.

In step 904, the client application signs the header using the private key. In step 905, the client application generates a DPoP JWT by packing the header and the signature.

In step 906, the client application transmits an access token request to an token endpoint that is administered by an authorization server. The access token request includes the DPoP JWT and the payload.

In step 907, the authorization server extracts the DPoP JWT from the access token request. The authorization server transmits the payload including the device fingerprint and/or the contactless card cryptogram to an authentication server.

In step 908, the authorization server verifies the signature using the public key included in the DPoP JWT. The verification ensures that the client application of the user device has the private key which corresponds to the public key.

In step 909, the authentication server authenticates the payload by performing an authentication process. The authentication server retrieves device fingerprint and/or contactless card cryptogram previously stored in a device fingerprint database. The authentication server compares the received device fingerprint in the payload with the retrieved device fingerprint from the device fingerprint database to determine whether the received device fingerprint matches with the retrieved device fingerprint (e.g., statistically match). If they match, the authentication server authenticates the payload and determines the payload is from the client application of the user device; if not, the authentication server can determine the payload is not from the client application of the user device. If the contactless card cryptogram is included in the payload, the authentication server compares the received contactless card cryptogram in the payload with the retrieved contactless card cryptogram from the device fingerprint database to determine whether the received contactless card cryptogram matches with the retrieved contactless card cryptogram. If they match, the authentication server authenticates the payload and determines the payload is from the client application of the user device; if not, the authentication server can determine the payload is not from the client application of the user device.

The authentication server may transmit to the authorization server a notification indicating whether the payload is authenticated. For example, if the authentication server authenticates the payload, the authentication server may transmit to the authorization server a notification notifying that the payload has been authenticated.

In step 910, the authorization server can generate an access token based on the successful signature verification and the payload authentication. In step 911, the authorization server binds the public key to the access token. For example, binding the public key to the access token can be achieved by remembering the hash value of the public key as one attribute of the access token. As an example, the hash value can be “JWK SHA-256 Thumbprint”.

In step 912, the authorization server issues the access token to the client application of the user device. The client application of the user device can then use the access token to access resources that are authorized by the authorization server and/or a resource server.

In step 913, the client application prepares a header including the public key and a payload. In step 914, the client application signs the header using the private key. In step 915, the client application creates a DPoP JWT including the header and the signature. In step 916, the client application creates and transmits an API call request to an API endpoint administered by a resource server for accessing resources. In this step, the client application creates the API call request by including the DPoP JWT and the access token into the API call request. The payload herein in the header corresponds to the API call request.

In step 917, the resource server extracts the DPoP JWT and the access token from the API call request. The resource server verifies the signature using the public key included in the DPoP JWT. The verification ensures that the client application of the user device has the private key which corresponds to the public key. The resource server checks whether the public key included in the DPoP JWT matches the public key bounded to the access token. For example, The resource server may compares the hash value of the public key included in the DPoP JWT with the hash value of the public key bounded to the access token. If they match, the access token included in the API call request can be verified to be the access token issued to the client application of the user device and the API call request is from the client application of the user device.

In step 918, the resource server can grant the client application of the user device access the requested resources.

In some aspects, the techniques described herein relate to an authorization and authentication method, including: receiving, by a server from a user device, a request to generate an access token, wherein: the request includes a demonstration of proof of possession (DPoP) token, the DPoP token includes a public key, a payload and a signature, and the payload includes at least one selected from the group of fingerprint data of the user device and a unique identifier of a contactless card associated with a user of the user device; extracting, by the server, the DPoP token from the request to generate an access token; verifying, by the server, the signature using the public key included in the DPoP token; authenticating, by the server, the payload; generating, by the server, an access token; binding, by the server, the public key to the access token; and transmitting, by the server, the access token to the user device.

In some aspects, the techniques described herein relate to a method, wherein the public key is associated with a private key generated by the user device.

In some aspects, the techniques described herein relate to a method, wherein the signature is generated using the private key by the user device.

In some aspects, the techniques described herein relate to a method, wherein the fingerprint data of the user device include at least one selected from a group consisting of a web browser setting of the user device, a processor type of the user device, an internet protocol (IP) address of the user device, and existing cookies stored on the user device.

In some aspects, the techniques described herein relate to a method, wherein the payload further includes an identifier of the user of the user device.

In some aspects, the techniques described herein relate to a method, wherein the identifier of the user includes an email address of the user.

In some aspects, the techniques described herein relate to a method, wherein the server includes an authentication server and an authorization server.

In some aspects, the techniques described herein relate to a method, wherein authenticating the payload is performed by the authentication server.

In some aspects, the techniques described herein relate to an authorization and authentication system, including a server, wherein the server include a processor and a memory coupled to the processor, and the server is configured to: receive from a user device a request to generate an access token, wherein: the request includes a demonstration of proof of possession (DPoP) token, the DPoP token includes a public key, a payload and a signature, and the payload includes at least one selected from the group of fingerprint data of the user device and a unique identifier of a contactless card associated with a user of the user device; extract the DPoP token from the request to generate an access token; verify the signature using the public key included in the DPoP token; authenticate the payload; generate an access token; bind the public key to the access token; and transmit the access token to the user device.

In some aspects, the techniques described herein relate to a system, wherein the server is configured to bind the fingerprint data of the user device to the access token.

In some aspects, the techniques described herein relate to a system, wherein the server is configured to bind the unique identifier of the contactless card to the access token.

In some aspects, the techniques described herein relate to a system, wherein the server is configured to bind both the fingerprint data of the user device and the unique identifier of the contactless card to the access token.

In some aspects, the techniques described herein relate to a non-transitory, computer-

readable medium including instructions for authorization and authentication that, when executed on a computer arrangement, perform actions including: receiving from a user device a request to generate an access token, wherein the request includes a demonstration of proof of possession (DPoP) token; the DPoP token includes a public key, a payload and a signature; and the payload includes at least one selected from the group of fingerprint data of the user device and a unique identifier of a contactless card associated with a user of the user device; extracting the DPoP token from the request to generate an access token; verifying the signature using the public key included in the DPoP token; authenticating the payload; generating an access token; binding the public key to the access token; and transmitting the access token to the user device.

In some aspects, the techniques described herein relate to a non-transitory, computer-readable medium, wherein the actions further includes receiving a request of accessing a resource data store, the request of accessing the resource data store including a second DPoP token and the access token.

In some aspects, the techniques described herein relate to a non-transitory, computer-readable medium, wherein the second DPoP token includes a second public key, a second payload and a second signature; and the actions further include: extracting the access token and the second DPoP token from the request of accessing a resource data store, verifying the second signature using the second public key, checking whether the second public key matches the public key bounded to the access token; and in response that the second public key matches the public key bounded to the access token, authorizing an access to the resource data store.

In some aspects, the techniques described herein relate to a non-transitory, computer-readable medium, wherein the actions further includes authenticating the second payload.

In some aspects, the techniques described herein relate to a non-transitory, computer-readable medium, wherein the second payload include fingerprint data of a second user device and/or a unique identifier of a second contactless card.

In some aspects, the techniques described herein relate to a non-transitory, computer-readable medium, wherein authenticating the second payload includes comparing the fingerprint data of the second user device with the fingerprint data of the user device.

In some aspects, the techniques described herein relate to a non-transitory, computer-readable medium, wherein the actions further includes, in response that the fingerprint data of the second user device matches with the fingerprint data of the user device, authorizing, by a server, the access to the resource data store.

In some aspects, the techniques described herein relate to a non-transitory, computer-readable medium, wherein authenticating the second payload includes comparing the unique identifier of the second contactless card with the unique identifier of the contactless card.

Throughout the disclosure, the term “Java web token (JWT)” is used, and it is understood that the present disclosure is not limited to a particular token or type of token. Rather, the present disclosure includes any type of token, cookie, or other data structure, including without limitation, JavaScript Object Notation (JSON) tokens, Simple Web Tokens (SWT), and Security Assertion Markup Language Tokens (SAML).

As used herein, the term “merchant” is not limited to a particular merchant or type of merchant. Rather, it is understood that the present disclosure includes any type of merchant, vendor, or other entity involving in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

In some examples, exemplary procedures in accordance with the present disclosure described herein can be performed by a processing arrangement and/or a computing arrangement (e.g., a computer hardware arrangement). Such processing and/or computing arrangement can be, for example entirely or a part of, or include, but not limited to, a computer/processor that can include, for example one or more microprocessors, and use instructions stored on a computer-accessible medium (e.g., RAM, ROM, hard drive, or other storage device). For example, a computer-accessible medium can be part of the memory of a user device, an authorization server, a server, or other computer hardware arrangement.

In some examples, a computer-accessible medium (e.g., as described herein above, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. In addition or alternatively, a storage arrangement can be provided separately from the computer-accessible medium, which can provide the instructions to the processing arrangement so as to configure the processing arrangement to execute certain exemplary procedures, processes, and methods, as described herein above, for example.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the disclosure, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An authorization and authentication method, comprising:
receiving, by a server from a user device, a request to generate an access token, wherein:
the request includes a demonstration of proof of possession (DPoP) token,
the DPoP token includes a public key, a payload and a signature, and
the payload includes at least one selected from the group of fingerprint data of the user device and a unique identifier of a contactless card associated with a user of the user device;
extracting, by the server, the DPoP token from the request to generate an access token;
verifying, by the server, the signature using the public key included in the DPoP token;
authenticating, by the server, the payload;
generating, by the server, an access token;
binding, by the server, the public key to the access token; and
transmitting, by the server, the access token to the user device.

2. The method according to claim 1, wherein the public key is associated with a private key generated by the user device.

3. The method according to claim 2, wherein the signature is generated using the private key by the user device.

4. The method according to claim 1, wherein the fingerprint data of the user device include at least one selected from a group consisting of a web browser setting of the user device, a processor type of the user device, an internet protocol (IP) address of the user device, and existing cookies stored on the user device.

5. The method according to claim 1, wherein the payload further includes an identifier of the user of the user device.

6. The method according to claim 5, wherein the identifier of the user includes an email address of the user.

7. The method according to claim 1, wherein the server comprises an authentication server and an authorization server.

8. The method according to claim 7, wherein authenticating the payload is performed by the authentication server.

9. An authorization and authentication system, comprising a server, wherein the server comprise a processor and a memory coupled to the processor, and the server is configured to:
receive from a user device a request to generate an access token, wherein:
the request includes a demonstration of proof of possession (DPoP) token,
the DPoP token includes a public key, a payload and a signature, and
the payload includes at least one selected from the group of fingerprint data of the user device and a unique identifier of a contactless card associated with a user of the user device;
extract the DPoP token from the request to generate an access token;
verify the signature using the public key included in the DPoP token;
authenticate the payload;
generate an access token;
bind the public key to the access token; and
transmit the access token to the user device.

10. The system according to claim 9, wherein the server is configured to bind the fingerprint data of the user device to the access token.

11. The system according to claim 9, wherein the server is configured to bind the unique identifier of the contactless card to the access token.

12. The system according to claim 9, wherein the server is configured to bind both the fingerprint data of the user device and the unique identifier of the contactless card to the access token.

13. A non-transitory, computer-readable medium comprising instructions for authorization and authentication that, when executed on a computer arrangement, perform actions comprising:
receiving from a user device a request to generate an access token, wherein the request includes a demonstration of proof of possession (DPoP) token; the DPoP token includes a public key, a payload and a signature; and the payload includes at least one selected from the group of fingerprint data of the user device and a unique identifier of a contactless card associated with a user of the user device;
extracting the DPoP token from the request to generate an access token;
verifying the signature using the public key included in the DPoP token;
authenticating the payload;
generating an access token;
binding the public key to the access token; and
transmitting the access token to the user device.

14. The non-transitory, computer-readable medium according to claim 13, wherein the actions further comprises receiving a request of accessing a resource data store, the request of accessing the resource data store including a second DPoP token and the access token.

15. The non-transitory, computer-readable medium according to claim 14, wherein
the second DPoP token includes a second public key, a second payload and a second signature; and
the actions further comprise:
extracting the access token and the second DPoP token from the request of accessing a resource data store,
verifying the second signature using the second public key,
checking whether the second public key matches the public key bounded to the access token; and
in response that the second public key matches the public key bounded to the access token, authorizing an access to the resource data store.

16. The non-transitory, computer-readable medium according to claim 15, wherein the actions further comprises authenticating the second payload.

17. The non-transitory, computer-readable medium according to claim 16, wherein the second payload include fingerprint data of a second user device and/or a unique identifier of a second contactless card.

18. The non-transitory, computer-readable medium according to claim 17, wherein authenticating the second payload comprises comparing the fingerprint data of the second user device with the fingerprint data of the user device.

19. The non-transitory, computer-readable medium according to claim 18, wherein the actions further comprises, in response that the fingerprint data of the second user device matches with the fingerprint data of the user device, authorizing, by a server, the access to the resource data store.

20. The non-transitory, computer-readable medium according to claim 17, wherein authenticating the second payload comprises comparing the unique identifier of the second contactless card with the unique identifier of the contactless card.
